(19) United States
(12) Patent Application Publication
(10) Pub. No.: US 2019/0118220 A1
(43) Pub. Date: Apr. 25, 2019

(54) Method for the Production of a Layer for Coating the Plastic Inner Surface of a Receptacle, and Receptacle Obtained by a Method of Said Type

(71) Applicant: Glass Surface Technology, Paris (FR)

(72) Inventors: Christophe Wagner, Bussiere-Poitevine (FR); Alexis Marsal, Limoges (FR)

(21) Appl. No.: 16/302,709

(22) PCT Filed: May 24, 2017
(86) PCT No.: PCT/FR2017/051301

§ 371 Date: Nov. 19, 2018

(30) Foreign Application Priority Data
May 25, 2016 (FR) 1654712

(51) Int. Cl. B05D 7/22; B05D 7/24; B05D 3/00; B65D 23/02; B65D 25/14

(52) U.S. Cl. CPC B05D 7/227; B05D 7/24; B05D 3/007; B65D 23/02; B65D 25/14; B05D 2401/21; B05D 2201/02; B05D 2203/35; B05D 2301/00; B05D 2259/00; B05D 2320/00

(57) ABSTRACT

The invention relates to a method for producing a barrier layer (13, 9) for coating the inner surface (12, 17) of a receptacle (10, 6) which is made at least in part of plastic and is used for holding products that are biocompatible for humans and/or animals; in said method, a solution is formed that contains at least one solvent, water, at least one organo-functional molecular precursor, and an acid as a catalyst, the complexed solution, which is undergoing hydrolysis and condensation, is applied to at least one portion of the inner surface of the receptacle, the applied solution is dried at a specific drying temperature below 100° C., and the receptacle is conveyed away and stored before being baked. The acid used is citric acid.

The present invention relates to a process for the manufacture of a layer for coating the internal face of a receptacle at least partly made of plastic.

It also relates to a receptacle obtained with such a process.

Manufacture of a layer for coating the internal face of a receptacle is understood to mean the manufacture of a covering solution which forms, after gelling and then solidification, a layer of protective material, and also the covering proper, that is to say the surface affixing of such a solution to the surface of an object formed of another material, in order to create, after gelling and curing, this protective layer in an integral and lasting fashion (that is to say, greater than several years). Such a coating then modifies the physical and/or chemical surface properties of this other material (when it comes into contact with a product).

Plastic is understood to mean any material resulting from polymerization, in particular of oil product and especially polyethylene bottles or more generally any bottle, pot, tube or flexible bag used in a way biocompatible with man or animals.

The invention has a particularly important although not exclusive application in the field of the manufacture of plastic bottles intended to receive and preserve processed foodstuffs, pharmaceutical products or cosmetic products.

It makes it possible in particular to minimize container/contents and/or environment/contents interactions, this being the case more particularly for storage requiring the preservation of products in a neutral way for a fairly long time (for example several months).

Conventionally, neutral support is understood to mean a support which carries out, over time, a release of ions in very small amount.

Very small amount is understood in particular to mean peaks of presence after extraction which are markedly lower than the treatment-free reference, for example two to ten times lower, the extractables being measured by gas phase chromatography coupled to mass spectrometry (GS-MS).

This is because studies have shown that some elements present in the bottle could migrate into the contents, in particular when the packaging is subjected to high temperatures.

This results in a contamination which may cause dangerous effects with regard to a pharmaceutical product, as a result of unacceptable reactions which might take place between the wall and the product.

Means for covering at least a fraction of the surface with a vitreous material prepared according to a process known to a person skilled in the art under the sol-gel (diminutive of solution-gelling) name are already known (FR 2 935 594).

The vitreous material, which is based on silica, is obtained without melting, by polymerization of at least one molecular precursor.

It comprises a synthesis stage carried out starting from alkoxides of formula M(OR)ₙ, where M is a metal or silicon and R is a CₙH₂ₙ₊₁ organic alkyl group dissolved in a conventional solvent, followed by a more or less lengthy stage of gelling with evaporation of the solvent until solidification is complete.

Such a sol-gel process is nevertheless particularly complex and problematic to carry out in a closed receptacle.

In addition, it exhibits the following disadvantages:

First of all, it leaves a residual acidity on the support during the use of the acids conventionally chosen, such as acetic acid or hydrochloric acid, which may modify the chemical behavior and/or the olfactory perception of the products present in the bottle.

However, in addition and in particular, this process has not identified the problem of the barrier and, for this reason, has neither sought nor makes it possible to sufficiently increase the hydrolytic resistance because a coating is generated which is too porous and/or regions which are poorly protected (holes) are left on the surface part concerned, where the deposition is carried out.

This is because it is found, with such a process, that the effectiveness of the function of barrier to releases and to exudation phenomena deteriorates over time with kinetics which are too rapid for the constraints of duration of preservation, in particular for applications in perfumery.

This type of process is in general also and specifically suited to a type of constituent material of the receptacle made of glass and cannot fully be extrapolated to plastic, even if this substance is theoretically mentioned, for this reason not being specifically ruled out as such by the prior art.

To sum up, it is observed in particular that the known processes, which use strong acids such as hydrochloric acid (HCl), naturally favored by a person skilled in the art for the preparation of reactive solutions and the increase in the kinetics of the reactions, on the one hand exhibit the disadvantage of allowing the passage of a residual amount of acid which in the long run interferes with the quality and the scent of the product and/or fragrance and, on the other hand, do not optimally provide a barrier with regard to the wall of the receptacle, resulting in releases into the product present.

The present invention makes it possible to overcome these disadvantages, in particular in that it makes it possible to treat plastic bottles, in that it significantly improves the hydrolytic resistances by generating a true barrier effect, that is to say an impermeability or leaktightness to the products which can be extracted from the wall of the receptacle, in that it optimizes the attachment of the layer to the internal wall of the receptacle, in that it makes it possible to functionalize the layer without doing so to the detriment of the hydrolytic resistances, mechanical strengths, thermal resistances and chemical resistances of the layer and in that it makes it possible to operate in a confined environment with, for example, application by a sprayer.

The invention also makes it possible to obtain set layers with a greater and more uniform thickness and with good reaction kinetics at the industrial level while providing treatment temperatures of less than 100° C.

In point of fact, the processes of the prior art provide heat treatments always including temperature values >120° C., 150° C., and the like, regarded as necessary by a person skilled in the art in order to obtain a satisfactory result.

With the invention, the final esthetic rendering of the layer is improved by significantly reducing the cracks and dents of the layer, this being done in a lasting manner over time, which is crucial in the field of luxury goods and of perfumery.

To sum up, the invention makes it possible to obtain a layer providing a neutral barrier which is impermeable to radiation and to chemical entities, this being achieved in both directions of passing through the layer.

It is thus in particular an object of the present invention to employ these principles with the abovementioned advantages.

The formulation of the solution must in addition make it possible to obtain a viscosity which makes possible the ready application of the solution while making possible gelling kinetics which limit the effects of the smears during the application, while making possible good stability over time, not leaving cracks in the applied layer after drying and/or baking.

In addition, they generally require the use of acid or of base so as to activate, that is to say to prepare, the surface state of the internal surface intended to be covered.

These acids, at the pH values envisaged, are very active products, indeed even products which are dangerous for the handler and for the receptacle.

The reactants of the prior art which can be used with such processes are furthermore not readily available on the market and/or are expensive, require restrictive safety procedures and impose limitations in terms of temperature, of time of treatment and of materials which can be used.

Furthermore, the acids used cannot be easily evacuated from a confined environment and are not removed efficiently enough when the temperature is raised.

With a plastic support, the layer adheres poorly, does not hold with regard to temperature and is weaker in the event of chemical attack.

The greater flexibility of the support can furthermore cause deformations when grasped and/or external stresses which may, for this reason, cause damage to the coating added.

The present invention is thus targeted at providing a process, and a receptacle obtained by such a process, responding better than those previously known to practical requirements, in particular in that, in addition to the elements indicated above, it does not absolutely require the use of harmful products to prepare the internal wall of the bottle or of the receptacle before treatment, in that it consequently does not require obligatory rinsing before and/or after use and in that, as mentioned above, it makes it possible to treat all the types of plastic bottles, independently of the suppliers of these and while generating less damage to the receptacles than in the prior art, and in that it makes possible good adhesion of the applied layer to the support, and also optimized protection, forming a true barrier layer, all this while operating in a confined environment.

The invention also makes it possible to obtain good reaction kinetics at the industrial level for lower treatment temperatures than in the prior art, which are compatible with the plastic support.

It is thus in particular an object of the present invention to employ these principles with the abovementioned advantages while overcoming the disadvantages of the prior art.

With this aim, it provides in particular a process for the manufacture of a barrier layer for coating the internal face of a receptacle, at least partly made of plastic, suitable for containing products biocompatible with man and/or animals, in which:
a solution containing at least one solvent, water, at least one organofunctional molecular precursor and citric acid, as catalyst, is formed,
the solution thus complexed is applied to at least a part of the internal face of the receptacle, the solution being in the course of hydrolysis and condensation, and
the solution thus applied is dried at a predetermined drying temperature of less than 100° C. before evacuation and storage.

It should be noted in particular that, to have good adhesion of the sol-gel layer to the plastic surface, with such low temperatures, was not truly known from the prior art, a person skilled in the part being on the contrary dissuaded therefrom.

Surprisingly, the above combinations have nevertheless made it possible to observe an excellent adhesion over several months/years.

Organofunctional molecular precursor is understood to mean a precursor of formula R′-M-(OR)ₙ, R′ being the organic functional group remaining in the layer, with at least one M-C bond, unlike the inorganic precursors of formula M(OR)ₙ, such as the materials based on silicas conventionally used with the sol-gel process.

In the course of hydrolysis and condensation is understood to mean the fact that the overall chemical reaction has not yet reached its final or maximum degree of progression.

It is known that the degree of progression ξᵣ of a reaction is defined by

$${ξ}_{r} = \frac{ξ}{{ξ}_{max}}$$

with ξᵣ ϵ [0;1] and
ξ: degree of progression at the given instant t
ξₘₐₓ: final or maximum degree of progression.

Furthermore, the progression of the reaction is defined by

$$d ξ = \frac{dni}{vi}$$

with
dnᵢ: variation in the number of moles from the initial instant and
υi: stoichiometric number of the reaction.

In the case in point, the degree of progression has to be at a value of less than 1, making possible the microspraying.

Alternatively, in the course of hydrolysis and condensation is thus also understood to mean that the solution in the course of gelling has, at the instant t, a viscosity which makes possible a homogeneous application, for example a dynamic viscosity at 20° C. of between 1 and 150, for example between 3 and 80, and in particular of less than 50 mPa.s, for example of less than 20 mPa.s, for example of less than 10 mPa.s.

This is because the progression of the reaction and the viscosity are related.

The density of the layer and also the possibility for the latter of being formed of a single closed surface (2 dimensions) devoid of holes, i.e. of 0 genus in topology, further increases the resistance to release of the internal surface of the bottle.

Receptacle at least partly made of plastic is understood to mean a receptacle entirely made of plastic and/or made of material covered, directly or indirectly, with a layer made of plastic, the internal face being the final surface exposed to the air before filling, directly or indirectly, with the product.

Solvent is understood to mean a substance other than water which has the property of dissolving, diluting or extracting other substances without chemically modifying them and without itself being modified.

Manufacture of a barrier layer for coating the internal face of a receptacle is understood to mean the manufacture of a covering solution which forms, after gelling and then solidification, a layer of protective material exhibiting a true leaktightness (impermeability) with regard to the migration of the elements coming from the receptacle, better than that observed with the prior art.

Such a barrier effect is observed when the hydrolytic resistance during successive measurements is on average better than with the prior art by at least ten percent, advantageously 30%, indeed even 50% and up to 80% (and thus the capacity for release, which is proportional to it).

Finally, the final stage of drying at a predetermined temperature advantageously takes place immediately after the application of the solution.

Immediately is understood to mean straightaway or within the few minutes which follow (<30 min).

It is this drying stage which definitively forms the hard barrier layer according to the embodiment of the invention more particularly described here and which will be used as is, after optional storage, to be filled with the biocompatible product.

No other process stage, such as heating or chemical treatment, is thus provided after this drying stage before the filling.

With the invention, the acid used is a weak acid, such as an acid extracted directly from lemon juice, which exhibits great ease of use, this being the case for low prices in comparison with other acids.

It should thus be noted that no subsequent heat treatment (in contrast to the prior art) is necessary in order to have good layer quality.

Despite the continual process of gelling/solidification, it is also possible to preserve, over the long term, the gel (partially gelled solution) produced from the above solution and to operate at ambient temperature.

With the invention, a greatly reduced release of ions by the receptacle is observed after extraction with a solvent and identification of the peaks of organic extracts by GC-MS (Gas Chromatography-Mass Spectrometry) in comparison with a coating-free reference.

In other words, the ability of a receptacle, the internal face of which is substantially entirely covered, to withstand the release of elements is improved.

Such a result is obtained without subsequent treatment and under appropriate storage conditions, the measurements being carried out, for example, by extraction with isopropyl alcohol at 40° C. for 6 h, followed by identification of the volatile extracts by GC-MS.

With the invention, it is thus found that subsequent releases, as tested in standardized fashion by gas chromatography (GC-MS) in order to identify the products, are lower than the quantification limit (<25 micrograms/sample).

In advantageous embodiments, recourse is had, furthermore and/or in addition, to one and/or other of the following arrangements:
the predetermined drying temperature is between 70° C. and 95° C. The drying is different from a baking in that it is carried out by a gradual rise in temperature and/or by blowing, whereas the baking is carried out in “seared” fashion in a baking oven.
the solution contains at least two organofunctional molecular precursors;
the organofunctional molecular precursors are taken from octadecyltrimethoxysilane, the family of the dipodal silanes and the family of the aminopropyl silanes.

This makes it possible to further improve the functional barrier (sufficiently leaktight to prevent the extraction from the surface of the plastic material) and also its uniformity (homogeneity) and its resistance to aging. By virtue of the reinforced action of these precursors, there is additionally observed a reinforced attachment appropriate to the plastic, in particular and especially by virtue of the amines and/or dipodal silanes.

Thus, in this specific embodiment of the invention, a truly effective reaction is obtained without high-temperature curing.

Advantageously, there is no simple metallic alkoxy molecular precursor;
the receptacle is entirely made of plastic;
the receptacle is made of glass, the internal face of which is covered with a plastic layer;
the solvent comprises butoxyethanol and/or ethanol;
the solution also comprises at least one pigment and/or one dye;
the citric acid is replaced with a weak acid;
the pigment is taken from metal oxides comprising cobalt and titanium, metal oxides comprising copper and chromium, or photochromic pigments and/or the dyes taken from the families of compounds comprising Pyrisma™ and/or Iriodin™ from Merck, quinacridone, phthalocyanine, quinophthalone and the compounds formed of a layer of aluminum and/or its oxides, said layer being itself coated with a layer of silicon oxide;
per 100 units by volume of final solution, the proportions are from 80 to 98 units of solvents, including, out of 100 units of solvents, at least 90 parts of ethanol, from 1 to 19 units of organofunctional precursors, from 0.02 to 0.15 unit of acid and from 0.1 to 1 unit, with or without addition of 1.5 to 6 grams of pigments and/or dye and/or functional additives per 100 ml of final solution.

According to the embodiments of the invention which are more particularly described, the organic functional groups, such as those of the amines and/or dipodal silanes, which render the protective layer hybrid (that is to say, organic and inorganic), are produced at the surface, either in contact with the receptacle (for the attachment) or in contact with the product, in order to improve the slip, the mechanical strength or also the density of the layer.

The invention also provides a receptacle obtained by the process described above.

It also relates to a receptacle comprising an internal face made of plastic suitable for containing products biocompatible with man and/or animals, characterized in that said surface is covered, over at least a part, with a solidified coating layer obtained from a solution comprising at least one solvent, water, at least one organofunctional molecular precursor and a catalyzing weak acid (advantageously citric acid), said coating layer forming a hybrid organoinorganic matrix arranged in order to produce a physicochemical barrier.

Advantageously, the coating comprises pigments and/or dyes.

With the invention, as the layer is dense and closed (0 topological genus), this makes it possible to withstand attacks from the solvents of the product and to thoroughly trap the additives.

In an advantageous embodiment, the receptacle is a tube which can be folded over and/or closed at its end (by pinching, sealing or folding over) (such as, for example, a toothpaste tube), made of plastic or coated with an internal layer made of plastic.

Also advantageously, the receptacle is a bag made of plastic or coated with a layer made of plastic.

A better understanding of the invention will be obtained on reading the description which follows of embodiments described below as nonlimiting examples and with reference to the FIGS. which accompany it, in which:

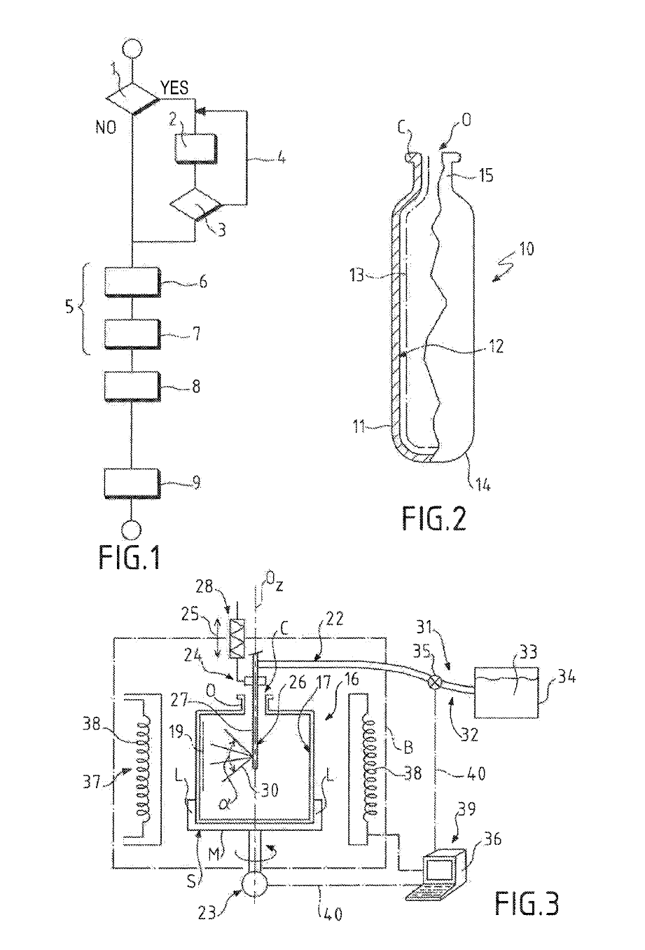

FIG. 1 is a flow diagram showing the stages of a process for the manufacture of a coating layer according to one embodiment of the invention.

FIG. 2 shows, in exploded partial view, a receptacle according to one embodiment of the invention.

FIG. 3 diagrammatically shows, in section, an embodiment of a device implementing the process according to one embodiment of the invention applied to a bottle.

FIG. 1 gives the flow diagram of the main stages of the process according to the embodiment of the invention more particularly described here.

The process comprises a preliminary stage (not represented) of supplying with at least one receptacle or bottle made of plastic to be treated, for example HDPE (high-density polyethylene).

The receptacle is formed of a material which, suitably treated, will make it possible to contain products biocompatible with man and/or animals, that is to say compatible with an ingestion and/or an application to the human or animal body (medicaments, cosmetic products, and the like).

The process comprises, subsequently or not (test 1), a stage 2 of passivation of the internal face of the receptacle.

It should be remembered that passivation is understood to mean an extraction, prior to the use of the bottle, of the elements liable to depart from the internal wall of the bottle during contact with liquid or pasty contents which will be subsequently stored therein.

The extraction has to be sufficient for the measurements by weight of these elements to be below a predetermined threshold set by the standards in force.

Each of the passivation embodiments (stage 2) can be repeated several times (test 3-4), for example twice.

This passivation stage further reduces the amount of ions which risk being released subsequently into the contents of the receptacle, in particular when the coating layer does not cover all or most of the internal surface of the receptacle. It also advantageously prepares the internal face for the adhesion of the coating layer.

The passivation stage can also be carried out by a treatment known to a person skilled in the art under the atmospheric-pressure plasma name.

After this stage, a stage 5 of preparation and formation of the solution according to the embodiment of the invention more particularly described here is carried out, if this has not been carried out beforehand in parallel or otherwise, for example in a separate place and in a period of time before its application which can reach several hours.

The preparation stage comprises a first stage of mixing the precursor(s) with at least one solvent and with aqueous acid solution (stage 6). The mixture is produced, for example, in a vat with stirrer at a predetermined temperature and for a predetermined time, for example at a temperature of between 10° C. and 50° C., for example of between 15° C. and 35° C., for example 24° C. (ambient temperature), and mixed for a period of time of, for example, between 10 min and 1 h, for example of between 25 min and 45 min, for example 30 min.

In the more particularly preferred embodiment described here, the acid is citric acid.

It is also here that the pigment is added, and then the mixture is subjected to ultrasound alternating with mixing (stage 7).

The mixing is thus carried out in an aqueous liquid, making possible hydrolysis of the precursor, and fluidifies the result obtained, making possible easy application.

The solution prepared in the end has a low concentration of citric acid, i.e. less than 0.01 mol/l.

The solution or sol is subsequently applied (stage 8) to the wall or walls made of plastic of the receptacle, as will be described, for example and more specifically, with reference to the device of FIG. 3.

Finally, a drying stage 9 is provided, the catalysis and the drying resulting in a gelling being obtained, which gelling gives a solid layer.

In the embodiments more particularly described here, the solvent is ethanol.

In a first embodiment, the molecular precursor is 3-glycidoxypropyltrimethoxysilane. The acid used is then nitric acid.

The sol-gel thus obtained has a viscosity which makes it more difficult to apply in receptacles of complex shapes but makes possible better control of the covering, for example a viscosity of less than 1 Pa.s at ambient temperature (approximately 24° C.).

In a second embodiment, the molecular precursor is octadecyltrimethoxysilane.

In a third embodiment, the precursor is (3-aminopropyl)triethoxysilane and the catalyst is citric acid.

Two examples which have given excellent results with the invention have been reproduced below.

Example 1: Hybrid organosilane layer on a pillbox made of plastic with pigments.

10 ml of EtOH (ethanol), 0.2 g of quinacridone pigments, 2 ml of octadecyltrimethoxysilane (or octa), 400 μl of dipodal BTSE, and 100 μl of citric acid (4 g+20 ml) are mixed for 4 h; gradual drying 80° C. by stationary phases of 5° C./min for 1 h.

More specifically, 10 ml of EtOH and 0.2 g of pigments are introduced into a flask; two subjections to ultrasound are subsequently carried out and then the 2 ml of octadecyl, the 400 μl of dipodal precursor and then the 100 μl of acid (4 g+20 ml) are introduced; then, after again subjecting to ultrasound, stirring is allowed to take place for 4 h, the preparation is then applied to the pillbox and drying is carried out at 80° C., the temperature being raised at a rate of 5° C./min, for 1 h.

Example 2: In a glass bottle, a layer for attachment to the glass, forming a layer made of plastic, is created from powder on the inside by deposition of the plastic in a way known per se, for example by deposition of thermoplastic powder.

In an advantageous embodiment, the coating is also put on the glass in order to make possible a better attachment of the plastic layer inside the bottle, taking advantage of the qualities of adhesion to plastic of the sol-gel of the invention.

First, for 5 h, 30 ml of EtOH, 600 μl of (3-aminopropyl)triethoxysilane and 60 μl of acid (4 g+20 ml) are mixed, before drying at 80° C., 5° C./min-1 h.

More specifically, 30 ml of EtOH, 600 μl of amino and 60 μl of acid (4 g of citric acid dissolved in 20 ml of water) are introduced into a flask and stirring is allowed to take place for 4 h.

The coating is applied to the bottle and the final step is a drying at 80° C., rising by 5° C./min, for 1 h.

Example 3:

Application of a coating layer containing an antibacterial function in a flexible tube open at one end and closed by the future screw dispenser at the other.

The mixture is prepared in the following way:

10 ml of ethanol, 2 ml of octadecyltrimethoxysilane precursor and 400 microliters of dipodal silane BTSE are introduced into a flask.

Stirring is carried out for 5 minutes, 100 microliters of citric acid (contributing water and acid) are then introduced, followed, 1 minute later, by 0.5 g of silver-based colloidal agent.

Mixing is carried out for 4 h after subjecting to ultrasound more than once. The product is subsequently sprayed into the tube and dried at 80° C. for 1 h. The tube can subsequently be filled and the open end closed by plastic welding.

With the invention, the solvent is instead ethanol, because it evaporates at a lower boiling point. Likewise, one of the advantageous cases which can be employed with the invention is the use of the layer with (3-aminopropyl)triethoxysilane on glass in order to act as underlayer for attachment of thermoplastic dusting inside the bottle made of glass (glass itself not compatible with the fragrance in this case), this being by virtue of the amine functional group.

This coating makes it possible not to treat the glass layer in a polluting fashion by virtue of this thermoplastic dusting.

With the invention, it is possible to attach a coating even in the presence of fragrances or other alcohol-comprising product, which is an amazing performance in itself, revealed by an aging test in the presence of fragrances at 50° C. for at least eight weeks without degradation of the layer and of the product.

In the case of the underlayer, it makes possible the attachment of the thermoplastic product 1): at T 0 during the deposition, 2): after aging at 40° C. for eight weeks in a climate-controlled (vacuum) chamber.

By way of example, the results of appearance, of hold toward rubbing of the coating and of hold toward eau de cologne (after one month in contact with the latter at 45° C.) with regard to two examples 4 and 5 have been represented below (table).

Examples 4 and 5:

Example 4 is a conventional sol-gel coating based on tetraethoxysilane with 10 ml of ethanol, 4 ml of TEOS, 4 ml of citric acid (4 g+20 ml) and 0.2 g of pigment, applied to a plastic pillbox made of HDPE and dried at 80° C. for 1 hour. The initial attachment and the appearance are correct, as is the static hold toward eau de cologne; on the other hand, the coating is not very resistant to rubbing.

Method of preparation: 10 ml of EtOH, 0.2 g of quinacridone rose pigment, 4 ml of TEOS and 4 ml of acid (4 g+20 ml) are introduced into a flask.

Example 5 according to the invention is a coating on the same pillbox made of HDPE which comprises 10 ml of ethanol, 2 ml of octadecyltrimethoxysilane, 0.4 ml of BTSE and 100 microliters of citric acid. After application, the coating is dried at 80° C. for 1 h and gives good results.

Method of preparation: 10 ml of EtOH and 0.2 g of pigment are introduced into a flask, the mixture is subjected to ultrasound twice and then 2 ml of octadecyltrimethoxysilane, 400 μl of BTSE and 100 μl of acid (4 g+20 ml) are introduced into the flask, and stirring is allowed to take place for 4 h.

In example 6, a conventional hybrid solution was tested, which solution in particular did not attach to the surface, from the contact with the eau de cologne.

TABLE

| | Appearance | Rubbing hold, coating | Eau de cologne hold |
|---|---|---|---|
| Example 4 | + | | + |
| Example 5 | ++ | +++ | +++ |
| Example 6 | − | −− | − − |

An excellent attaching is thus found with the examples commonly within the scope of the invention, while retaining a satisfactory appearance and a good hold over time toward eau de cologne, better than with the prior art (example 6).

FIG. 2 shows a bottle 10 made of plastic intended to receive a product biocompatible with man, for example of cylindrical shape, partially in section.

It comprises a wall 11 provided with an internal face 12 liable to be covered with a coating 13 (as dot-and-dash line) according to the invention, for example over the entire height of these walls from the bottom or base 14 of the receptacle to the bottleneck 15, forming an opening O.

The opening O of the bottleneck 15 comprises a neck C with a smaller diameter than that of the bottle 10.

An embodiment of a device which makes it possible to implement the invention will now be described without implied limitation, with reference to FIG. 3.

Subsequently, the same reference numbers can be used to denote identical or similar elements.

More specifically, FIG. 3 shows a device 22 for coating 19 at least a portion of the internal surface 17 of a receptacle 16, in this instance, for example, forming a cylindrical vial or bottle made of plastic extended with a cylindrical neck C, around an axis O_{z}. It thus comprises, at one of its ends (top end), an opening O as a bottleneck, the opening of the bottleneck comprising the neck C with a smaller diameter than that of the receptacle or bottle 16.

The receptacle thus substantially forms a chamber.

The device comprises a support S of the receptacle, for example comprising a retention clamp M in the shape of a dish or of a U, the branches L of which grip the base, that is to say the bottom, of the receptacle fixed via lateral screws (not represented).

Means 23 for rotating the receptacle around its axis O_{z} at a predetermined speed V are provided which are known per se. The speed V can be unchanging or variable and regulated. More specifically, the means comprise, for example, a rotating rod for driving the support which extends along the axis O_{z} and a motor for driving in a way known per se.

Means 24 for insertion/extraction (arrow 25) of a spraying tool or nozzle 26 inside the receptacle are mounted on a frame B, as dot-and-dash lines in the FIG., on the side of the bottleneck of the receptacle 16.

The nozzle 26 comprises a longitudinal shaft or tube 27 connected, at its end 28, to the insertion means 24 comprising an actuator 23 for longitudinal displacement, such as a jack.

The action of the jack, which is integral with the nozzle 26, relocates the latter from an initial position external to the receptacle 13 to a position of operation internal to the receptacle along the axis O_{z}.

It thus makes possible a gradual descent, continuous or stepwise, of the tool for application of the coating solution (gel in formation) to the internal surface of the receptacle.

The nozzle brings about vaporization 30 along a predetermined solid angle α for dispersion which depends on the ejection rate and pressure controlled in a way known per se.

The tube is connected, at its opposite end, to a system 31 for dispensing a liquid coating solution to be sprayed comprising means 32 for feeding with liquid or substantially liquid solution 33 in order to make possible the spraying, at a predetermined flow rate D.

The system 31 thus comprises a tank 34 for storage of said liquid and means 35 for moving the liquid (metering pump) arranged in order to regulate the flow rate D of the liquid via a calculator 36 and also controls the other actuators employed in the device.

The tank comprises, in its bottom, a mixing means, for example a stirrer (not represented).

The coating gel is the curable liquid coating material obtained by the sol-gel process described above.

The device also comprises means 37 for heating the receptacle 13 which are known per se which make possible the rise in the temperature of a part of the internal surface of the receptacle up to a predetermined temperature threshold for the drying.

More specifically, the heating of the internal surface is carried out, for example, by direct radiation from heating resistors 38 positioned outside the receptacle or by diffusion around the wall of the receptacle positioned in contact, for example, with a heating muffle (not represented).

In one embodiment, the receptacle and the resistor are substantially confined in one and the same chamber so as to form an oven for homogeneous heating of the receptacle.

The device also comprises a computer or automaton 39 for digital control comprising the calculator 36.

These are connected via a data bus 40 and in a way known per se to the actuators of the device, namely to those of the retention clamp of the receptacle, that is to say of the motor for driving in rotation, to those of the means 24 for insertion of the nozzle 26 into the receptacle (jack), the stirrer, and also to those of the means 35 for moving/feeding with liquid (pump, valve, nozzle) and heating means 37 (electrical resistors).

The calculator 36 is arranged in order to calculate, from the different set points imposed, a law for controlling each of the actuators in a way known per se.

As is obvious and as also results from the above, the present invention is not limited to the embodiments more particularly described. On the contrary, it encompasses all the alternative forms thereof and in particular those where the device implementing the process is different.

The application can thus and for example be carried out by lettering or stamp.

The principle here is to use a stamp in the form of a letter or pattern made of rubber (sufficiently small to be introduced into the neck of the bottle) topped/soaked with sol-gel and then introduced at the end of a shaft (automated/articulated subsequently) into the bottle before being applied to the surface of the glass. The stamp is subsequently taken out again from the bottle. The sol-gel is subsequently dried normally, as described above.

The application of a layer which is reactive toward UV radiation to the internal surface, followed by exposure, can also be the process used. Use is then made of a gelatin with ammonium dichromate or diazidostilbene, for example, as additional additive, reactive pigments being added to the sol-gel.

The reactive pigments are added directly to the sol-gel, a negative is adhesively bonded to the external surface of the bottle and then a strong UV light is applied through the negative in order to develop the image; the excess is washed off before drying.

It is also possible to apply the reactive layer as above and then the transparent (or colored) sol-gel is applied as internal protective surface for the product present.

Another embodiment uses printing pins.

In this instance, the principle is as follows:

One of the pin-shaped printing valves is introduced via the neck. Control of the valve makes it possible to produce fine drops close to the interior surface (ink jet type), and thus to draw a pattern is possible by controlling the relative movement of the pin with respect to the surface and also the ejection of the drop. These pins are shape-memory pins; they can be curved in order to approach internal surfaces.

It is also possible to produce arched pins which can eject drops in a desired direction.

These valves (LeeCo) have a diameter of approximately 6 mm, being able to be completely introduced into the majority of bottles. Once introduced, these valves can be inclined (for example with a robot) in order to be able to discharge more accurately into the axis of the nozzles.

With the invention, and by using a spraying system and also an appropriate specific program, while sufficiently lowering the pressure of the spraying air, the system can thus eject droplets of greater size than in normal operation. Handling in this way makes it possible to produce a “speckled” effect never obtained to date.

1. A process for the manufacture of a barrier layer (13, 19) for coating the internal face (12, 17) of a receptacle (10, 16), at least partly made of plastic, suitable for containing products biocompatible with man and/or animals, in which:
a solution containing at least one solvent, water, at least one organofunctional molecular precursor and citric acid, as catalyst, is formed (5),
the solution thus complexed is applied (6) to at least a part of the internal face of the receptacle, the solution being in the course of hydrolysis and condensation, and
the solution thus applied is dried (7) at a predetermined drying temperature of less than 100° C. before evacuation and storage.

2. The process as claimed in claim 1, characterized in that the predetermined drying temperature is between 70° C. and 95° C.

3. The process as claimed in claim 1, characterized in that the solution contains at least two organofunctional molecular precursors.

4. The process as claimed in claim 1, characterized in that the organofunctional molecular precursor is taken from octadecyltrimethoxysilane, the family of the dipodal silanes and the family of the aminopropyl silanes.

5. The process as claimed in claim 1, characterized in that the receptacle is entirely made of plastic.

6. The process as claimed in claim 1, characterized in that the receptacle is made of glass, the internal face of which is intended to be covered with a layer of plastic.

7. The process as claimed in claim 1, characterized in that the solvent comprises butoxyethanol and/or ethanol.

8. The process as claimed in claim 1, characterized in that the solution also comprises at least one pigment and/or one dye.

9. The process as claimed in claim 8, characterized in that the pigment is taken from metal oxides comprising cobalt and titanium, metal oxides comprising copper and chromium, or photochromic pigments and/or the dyes taken from the families of compounds comprising Pyrisma™ and/or Iriodin™, which are registered trademarks of Merck, quinacridone, phthalocyanine, quinophthalone and the compounds formed of a layer of aluminum and/or its oxides, said layer being itself coated with a layer of silicon oxide.

10. The process as claimed in claim 1, characterized in that, per 100 units by volume of final solution, the proportions are from 80 to 98 units of solvents, including, out of 100 units of solvents, at least 90 parts of ethanol, from 1 to 19 units of organofunctional precursors, from 0.02 to 0.15 unit of acid and from 0.1 to 1 unit, with or without addition of 1.5 to 6 grams of pigments and/or dye and/or functional additives per 100 ml of final solution.

11. A receptacle (10, 16) comprising an internal surface (12, 17) made of plastic and suitable for containing products biocompatible with man and/or animals, characterized in that said surface (12, 17) is covered, over at least a part, with a solidified coating layer (13, 19) obtained from a solution comprising at least one solvent, water, at least one organofunctional molecular precursor and citric acid, as catalyst, said coating layer forming a hybrid organoinorganic matrix arranged in order to produce a physicochemical barrier.

12. The receptacle as claimed in claim 11, characterized in that the coating comprises pigments and/or dyes.

13. The receptacle as claimed in claim 10, characterized in that it is formed of a tube which can be folded over and/or closed at its end and/or by a bag made of plastic or coated with an internal layer made of plastic.
